(19) United States
(12) Patent Application Publication
(10) Pub. No.: US 2013/0255373 A1
(43) Pub. Date: Oct. 3, 2013

(54) Method and Apparatus for Measuring Water Level

(71) Applicant: Kwai Sang So, Shatin (HK)

(72) Inventor: Kwai Sang So, Shatin (HK)

(21) Appl. No.: 13/989,724

(22) PCT Filed: Feb. 11, 2011
(86) PCT No.: PCT/IB11/50559

§ 371 Date: Jun. 19, 2013

(30) Foreign Application Priority Data
Nov. 25, 2010 (HK) 10110987.2

(51) Int. Cl. G01F 23/284

(52) U.S. Cl. CPC G01F 23/284
USPC 73/290 V

(57) ABSTRACT

A method and apparatus for measuring water level in a container using RFID tag is provided. The water level tag group mounted inside the container is tested by a signal transmission and receiving device in order to determine whether there is a complete water level tag group in the testing area or not. Further, one complete water level tag group is chosen, and an inquiry process is made to all RFID tags of the selected complete water level tag group by the signal transmission and receiving device. An effective RFID tag will respond to the inquiry by sending out a radio frequency signal to the signal transmission and receiving device. The signal transmission and receiving device will then perform a data analysis and select a minimum water level value so as to obtain a real-time water level value of the container.

### TECHNICAL FIELD

The present invention relates to a water level measuring apparatus. Specifically, the present invention relates to a measuring method for measuring water level in a container and an apparatus adapted for using the measuring method. More specifically, it relates to the measuring method for measuring water level in a plant pot and the apparatus adapted for using the measuring method to measure water level in the plant pot.

### BACKGROUND OF THE INVENTION

Originally, if the user want to measure the water level in a container, he is required to put the fluviometer into a container, which is complex and takes time; with the planting application art, plant containers generally have a pot structure and regular and a certain volume of watering is required for flowers planted in containers. If the water level in a plant container is too high, root rot may occur easily; if the water level in a plant container is too low, the flower may die due to shortage of water. A common plant container generally has a closed structure and the water level in the plant container can't be observed directly. Thus people need to take a lot of time and energy to often observe the humidity of the soil in the plant container or insert a fluviometer into the plant container to judge the water level of the plant container. However, the above method requires certain experience and wastes time and energy, and the user must contact the plant in the plant container in order to insert the fluviometer into the plant container, which unavoidably damages the plant. Moreover, it is not easy for ordinary people to master the technique of measurement.

According to the prior arts, it appears transparent plant containers. Although the water level in transparent plant containers can be obtained through visual inspection, the result is inaccurate, which is not favorable to precise determination of the volume of watering for flowers. Likewise, in other occasions, there exists the need to obtain the precise water level in plant containers in a non-intrusive way.

### SUMMARY OF INVENTION

The present invention provides a water level measuring apparatus comprising a signal transmission and receiving device; a container for receiving a liquid; the container comprising a first signal device mounted inside the container; and the first signal device adapted for receiving radio-frequency signal transmitted from the signal receiver and transmitter and transmitting the radio-frequency signal to the signal receiver and transmitter.

Typically, the first signal device and a second signal device are positioned in different vertical positions within the container.

Typically, the first signal device and at least one second signal device are spaced apart in a vertical relationship on a wall of the container.

Typically, the second signal device is positioned above the first signal device.

Typically, the first signal device is a RFID tag.

Typically, the second signal device is a RFID tag.

Typically, the first and second signal devices comprising a processor, the processor is adapted for data storing, data processing, modulating and demodulating a radio-frequency signal transmitted from the signal transmission and receiving device.

Typically, the processor comprises integrated circuits.

Typically, the first and second signal devices comprises an antenna for receiving and transmission of the radio-frequency signal.

Typically, the first and second signal devices do not transmit radio-frequency signal when the devices are immersed in the liquid.

Typically, the signal transmission and receiving device comprises a network processing device for receiving data from the first and second signal devices and communicating with an information processing device through a method of electronic communication.

Typically, the container is a plant pot.

Typically, a water level measuring method comprising the steps of setting a water level tag group is within the container, the water level tag group comprising at least one RFID tag mounted inside the container; transmission of the radio frequency signals by the signal transmission and receiving device, the RFID tag storing electronic data comprising water level data; testing the RFID tag of the water level tag group by the signal transmission and receiving device, the effective RFID tag being positioned above the water level of the container sends out the radio frequency signal response to the test of the signal transmission and receiving device; the radio frequency signals being sent by effective RFID tag is received by the signal transmission and receiving device for analysis and reporting the user the water level data of the container by the signal transmission and receiving device.

Typically, a water level measuring method for a plant container comprising the steps of S10: setting the water level tag group inside the plant container, the water level tag group comprising at least one RFID tag mounted inside the plant container, the water level data corresponding to the depth of the plant container preset in each RFID tag; (the water level data can refer to water level values or sequential values corresponding to water level values; ID values refer to the value to distinguish one RFID tag from other RFID tags of the same water level tag group; the ID value comprising total values for distinguishing one RFID tag from other RFID tags and group type values for distinguishing one patent container from other plant containers) S20: entering the testing area of the water level tag group for testing and recording the existence of a complete water level tag groups by the movable signal transmission and receiving device in the testing area; if there is no complete water level tag group in the testing area, the signal transmission and receiving device will not perform any operation; S30: selecting one complete water level tag group from at least two complete water level tag groups in the testing area by the signal transmission and receiving device; S40: inquiring each RFID tags of the selected complete water level tag group by the signal transmission and receiving device, replying the inquiry from the signal transmission and receiving device by the effective RFID tag positioned above the water level of the plant container, transmission of the water level data to the signal transmission and receiving device; no response to the inquiry of the signal transmission and receiving device made by the RFID tag positioned below the water level of the plant container; S50: comparing the water level data between each effective RFID tags by the signal transmission and receiving device, selecting one water level data of a minimum water level value, converting the one water level data into a minimum water level value for output.

Typically, the S30 comprises a preset selection method, the signal transmission and receiving device selects one complete water level tag group from at least two complete water level tag groups in the preset selection method, the preset selection method can select a first complete water level tag group or select a last complete water level tag group or make random selection.

Typically, each RFID tag stores a ID value for distinguishing one RFID tag from other RFID tags of the same water level tag group, the S20 comprising the steps of S21: testing the existence of the RFID tag in the testing area; if the RFID tag appears in the testing area, the signal transmission and receiving device reads the ID value of the RFID tag; if no RFID tag appears in the testing area, no action will be taken by the signal transmission and receiving device; S23: according to the ID value, the signal transmission and receiving device groups all RFID tags in the manner of classifying RFID tags in the same water level tag group into the same group; S25: the signal transmission and receiving device judges whether RFID tags in each water level tag group are complete, and records the ID value of each complete water level tag group; if there is no complete water level tag group, then no action will be taken by the signal transmission and receiving device.

Typically, the signal transmission and receiving device comprising a display device and a input device, the signal transmission and receiving device of the S30 selecting one complete water level tag group by the steps of S31: the signal transmission and receiving device outputs the ID values of all complete water level tag groups to the display device, and the display device displays a display data corresponding to all ID values; S33: the user inputs a selection signal corresponding to the display data and S35: according to the selection signal, the signal transmission and receiving device records the ID values corresponding to the display data, and take such water level tag group corresponding to the ID value as the selected complete water level tag group.

Typically, all RFID tags of the S10 are in a vertical relationship and are spaced apart with a same distance.

Typically, the water level tag group mounted inside the plant container and the movable signal transmission and receiving devices, the said water level tag group comprising at least two RFID tags mounted inside the plant container at different vertical positions, each the RFID tag preset with the water level data corresponding to a preset vertical position in the plant container, the signal transmission and receiving device comprising a Test module, to send test signal test and record complete water level tag groups in the testing area; a Selection module, to select one water level tag group from complete water level tag groups; an Inquiry module, to send an inquiry signal to all RFID tag in the complete water level tag group and read the water level data of the effective RFID tag; a Comparison module, to select the water level data from the minimum water level value of the effective RFID tag acquired from the inquiry module and Output module, to convert the water level data acquired from the comparison module into the minimum water level value for output; The RFID tag comprising a Response module, to respond a test signal sent by the test module of the signal transmission and receiving device; an Output module: When this RFID tag is positioned above the water level of the plant container, it responds to the inquiry signal sent by the inquiry module of the signal transmission and receiving device, and returns to the preset water level data, but when this RFID tag is positioned below the water level of the plant container, it will not respond to the inquiry signal.

Typically, the RFID tag is preset with the ID value for distinguishing one RFID tag from other RFID tags of the same water level tag group and the test module of the signal transmission and receiving device comprising a Transmission sub-module, to send a test signal; a Reading sub-module, to read the ID value returned by the RFID tag existing in the testing area; a Grouping sub-module: according to the ID value acquired from the reading sub-module, to group all RFID tags in the manner of classifying the RFID tags in the same water level tag group into the same group; a Decision sub-module: to decide whether RFID tags in each water level tag group are complete and to record the ID value of each complete water level tag group.

Typically, the selection module of the signal transmission and receiving device further comprising the display device and the input device, the selection module inputting the ID value of all complete water level tag groups into the display device; the display device displays to the user the display data corresponding to the ID value, the user inputs one selection signal corresponding to the display data; the selection module records the ID value corresponding to the display data and takes water level tag group corresponding to the ID value as the selected complete water level tag group.

Typically, all RFID tags are in a vertical relationship and are spaced apart with a same distance.

Typically, the water level data preset in the RFID tag is the water level value corresponding to the RFID tag.

Typically, the water level information preset in the RFID tag is the sequential value of the RFID tag of the water level tag group.

Typically, the plant container comprises the water level tag group corresponding to the signal transmission and receiving device, the water level tag group comprises at least two RFID tags positioned in different vertical position of the plant container, each RFID tag is preset with the water level data corresponding to the vertical positions of the plant container; the RFID tag comprises the response module for replying the test signal sent by the signal transmission and receiving device and the output module for replying the inquiry signal from the signal transmission and receiving device and records the water level data when the RFID tag is positioned above the water level of the plant container, the output module will not respond the inquiry signal when the RFID tag is positioned below the water level of the plant container.

Typically, the RFID tag is preset with the ID value for distinguishing one RFID tag from other RFID tags of the same water level tag group, the response module of the RFID tag responds to the test signal sent by the signal transmission and receiving device and returns to the ID value of the RFID tag.

Typically, the ID value of the RFID tag comprises group sections and counting sections for recording the information of group values and total value.

Typically, the position of all RFID tags mounted inside the plant container is of a same vertical distance.

Typically, the water level data preset in the RFID tag is the water level value corresponding to the RFID tag.

Typically, the water level information preset in the RFID tag is the sequential value of the RFID tag of its water level tag group.

### DESCRIPTION OF THE DRAWINGS

This and other objects, features and advantages of the present invention will become apparent upon reading of the following detailed descriptions and drawings, in which:

FIG. 1 show flow chart of an embodiment of the present invention;

FIG. 2 shows a flow chart of the Step S20 of an embodiment of the present invention;

FIG. 3 shows a flow chart of the Step S30 of an embodiment of the present invention;

FIGS. 4, 4a and 4b show operation diagrams of the measuring apparatus of an embodiment of the present invention; and

FIG. 5 shows a structural diagram of the plant pot of an embodiment of the present invention.

### DETAILED DESCRIPTION OF THE INVENTION

As shown in FIG. 5, in the preferred embodiment of a method and apparatus for measuring water level according to the present invention, a water level measuring apparatus comprises a signal transmission and receiving device and container 10 that can carry liquid or plants. Water level tag group 50 comprises RFID tag 51 or the first signal device or the second signal device arranged on the interior wall of container 10. RFID tag 51 can receive a radio frequency (RF) signal sent by the signal transmission and receiving device and send response RF signals to the signal transmission and receiving device. RFID tag 51 and other RFID tags 51 are on vertically different positions in the container 10. RFID tag 51 and other RFID tags 51 can be vertically arranged on the wall of the container 10 separately or in an overlap manner. Each RFID tag 51 is provided with a processing device which stores or processes data, and modulates or demodulates RF signals sent by the said signal transmission and receiving device. Each RFID tag 51 is also provided with an antenna and the said antenna receives or sends RF signals. In addition, RFID tags can store electronic data, including data on water level in containers.

When the signal transmission and receiving device sends RF signals, the RFID tags in the said water level tag group are detected; after the valid RFID tag 51 above the water level of the container receives the RF signals, it will generate magnetic field, thus generates current to drive the processing device in RFID tag 51; the processing device outputs data after analysis and sends RF signals to the signal transmission and receiving device. After receiving the RF signals, the signal transmission and receiving device makes analysis, prompts the user with the data on the water level in container 10, and sends related real-time data to the remote computer or receives real-time data sent by the remote computer through an electronic transmission device.

RFID tag 51 below the water level of the container is deemed an invalid RFID tag 51, as RF signals will become weak or null after passing through the liquid in container 10, thus no current is generated to drive the processing device in RFID tag 51. Finally, the invalid RFID tag 51 can't send RF signals to the signal transmission and receiving device.

Additionally, to reach the effect of water level detection, RFID tags 51 must be arranged on different heights on the wall of container 10, therefore, RFID tag 51 or the second signal device must be arranged above the other RFID tag 51 or the first signal device. The water level measuring apparatus according to the present invention can be also used for plant container irrigation detection.

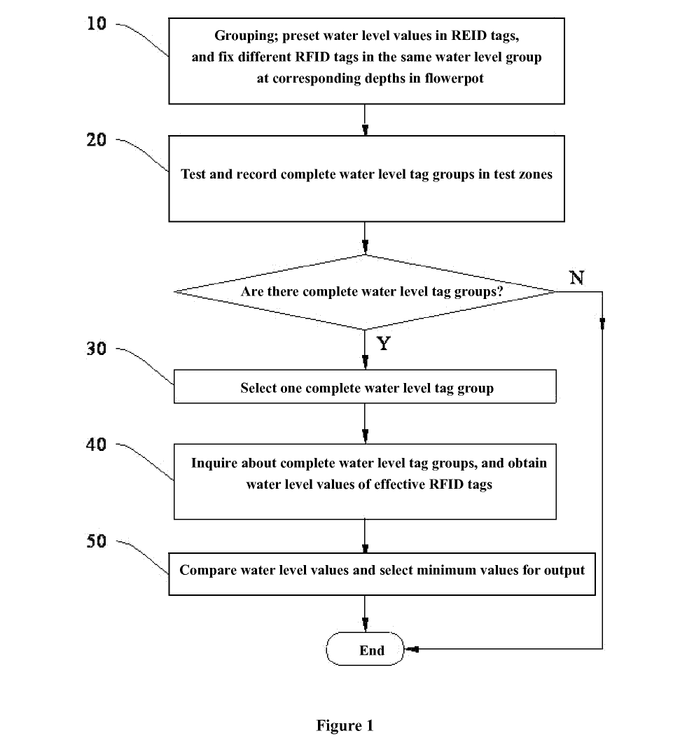

Additionally, as shown in FIGS. 1, 2 and 3, the preferred embodiment of a water level measuring apparatus and method according to the present invention comprises these steps: firstly, arrange the water level tag group in the plant container, wherein a water level tag group comprises multiple RFID tags arranged at different depths in the plant container and each RFID tag pre-stores data on the water level corresponding to their respective depth in the plant container, as shown by Step S10 in FIG. 1.

Then move the signal transmission and receiving device into the area of the water level tag group, and detect and record the complete water level tag groups in the testing area, as shown by Step S20 in FIG. 1. If there is no complete water level tag group in the testing area, the signal transmission and receiving device will not operate any longer, in which case, the signal transmission and receiving device should be moved to be near the plant container or the direction of the signal transmission and receiving device should be adjusted before restarting. If there is any complete water level tag group, it indicates that the water level of the plant container can be detected effectively. Proceed to the next step, as shown by Step S27 in FIG. 1.

As there may be multiple plant containers in the testing area and all RFID tags of the water level tag groups in the plant containers are all in the testing area, multiple complete water level sets may be obtained after the above steps. Use the signal transmission and receiving device to select a complete water level tag group from the above multiple complete water level tag groups, as shown by Step S30 in FIG. 1. In Step S30, the signal transmission and receiving device may be set to select one set from the multiple complete water level tag groups with the preset selection method. Preset selection methods may be selecting the complete water level tag group that appears first or last or selecting randomly. Manual selection by the user is preferable to prevent the signal transmission and receiving device from frequently selecting the same complete water level tag group in the mode of automatic selection, which causes not being able to obtain the information on the water levels of other plant containers.

Use the signal transmission and receiving device to inquire the RFID tags in the selected complete water level tag group, and the valid RFID tags above the water level of the plant container will respond to the inquiry of the signal transmission and receiving device and output the data to the signal transmission and receiving device; the invalid RFID tags below the water level of the plant container will not respond to the inquiry of the signal transmission and receiving device, as shown by Step S40 in FIG. 1.

Use the signal transmission and receiving device to compare the water level data of the valid RFID tags, select the water level data representing the minimum water level value, convert the water level data to the minimum water level value, and output it. As the valid RFID tags are above the water level and the RFID tag representing the minimum water level value is nearest to the water level in the plant container, therefore, the water level data of the RFID tag represents the water level in the plant container, thus the real-time water level in the plant container is obtained, as shown by Step S50 in FIG. 1.

With this method, just hold the signal transmission and receiving device and aim it at the plant container to be detected, and the real-time water level value of the plant container is obtained quickly and easily, thus avoids direct contact of the plant container or inaccuracy of visual inspection.

In the preferred embodiment, an ID value is pre-stored in each RFID tag to distinguish from other RFID tags in the water level tag group. One ID value corresponds to one RFID tag. An ID value can be arranged to contain a set segment and a counting segment which record the set value and total number value of the RFID tag respectively, wherein the group segment represents the water level tag group of the RFID tag and is used to distinguish from RFID tags in other water level tag groups; the total number value represents the total number of all RFID tags in this water level tag group. When the ID value of a RFID tag is obtained, the water level tag group of the RFID tag, i.e. in which plant container, and the number of RFID tags in the water level tag group can be judged based on the ID value.

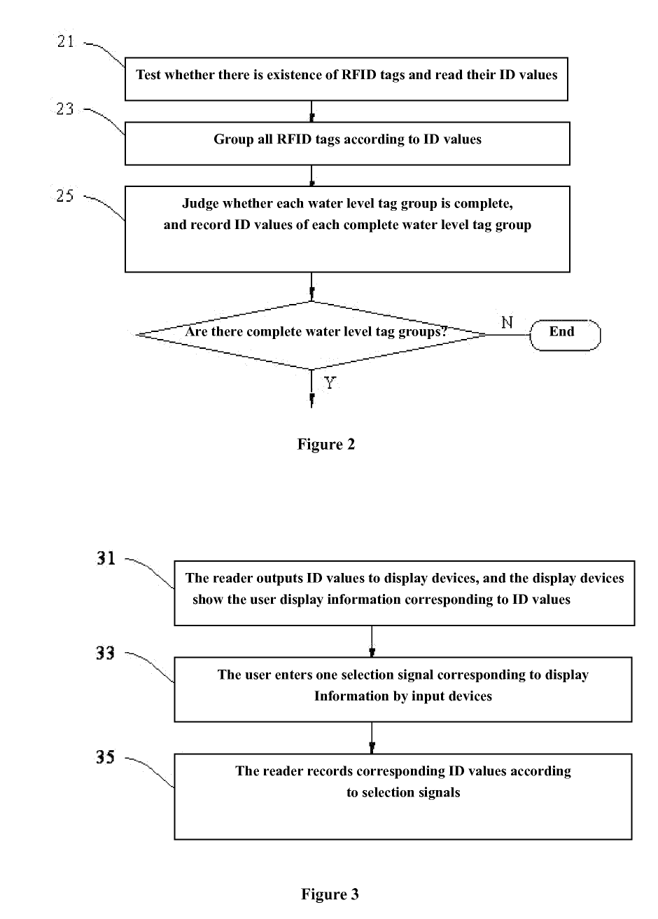

As shown in FIG. 2, in the preferred embodiment of the plant container water level measuring method according to the present invention, in the above Step S20, these sub-steps are preferable: firstly, detect whether there is any RFID tag in the testing area. If there is any RFID tag in the testing area, the signal transmission and receiving device will read the ID value of the RFID tag; if there is no RFID tag in the testing area, the signal transmission and receiving device will not operate any longer, as shown by Step S21 in FIG. 2. Thus, the ID values of all RFID tags in the testing area are obtained. As one ID value corresponds to one RFID tag, the selection and comparison of ID values equal to the selection and comparison of the RFID tags corresponding to the ID values.

Based on the ID values, the signal transmission and receiving device groups all RFID tags in the same water level tag group into the same group, as shown by Step S23 in FIG. 2. As ID values contain set data, such as the above set value, the RFID tags corresponding to the ID values with the same set value belong to the same water level tag group. Based on the set data in ID values, compare all ID values and group the ID values with the same set value into the same group to realize grouping of all RFID tags, thus the RFID tags in the same water level tag group are in the same group.

Use the signal transmission and receiving device to judge whether the RFID tags in each water level tag group are complete and record the ID values of each complete water level tag group. If there is no complete water level tag group, the signal transmission and receiving device will not operate any longer, as shown by Step S25 in FIG. 2. As an ID value further comprises a counting segment, such as the above total number value, whether the group of RFID tags include all RFID tags in this water level tag group, that is whether the water level tag group is complete, can be judged based on the ID values of the RFID tags in the same water level tag group, thus determines whether all RFID tags in this water level tag group are all in the testing area. Particularly, all ID values in this group can be counted to judge whether the number of RFID tags in this group is the total number of RFID tags in this group, thus determines whether the RFID tags in this group are complete. If the RFID tags in a group are complete, it is a complete water level tag group. Recording of the ID value of either RFID tag in the water level tag group is adequate, as the set segments in the ID values of the RFID tags in the water level tag group are the same. Thus all complete water level tag groups in the testing area are picked.

In the preferred embodiment, in Step 30, manual selection is preferable for selecting from multiple complete water level tag groups obtained. Particularly, the signal transmission and receiving device further comprises a display device and an input device. The signal transmission and receiving device outputs the ID values of all complete water level tag groups to the display device, and the display device shows multiple display data to the user. The multiple display data corresponds to the ID values one by one, as shown by Step S31 in FIG. 3. Based on the display data, the user inputs one selection signal matching with the selected display data through the input device, as shown by Step S33 in FIG. 3. Based on the records of selection signals and the ID value corresponding to the selected display data, the signal transmission and receiving device takes the water level tag group matching with the ID value as selected complete water level tag group, as shown by Step S35 in FIG. 3.

In the preferred embodiment of the above plant container water level measuring method according to the present invention, the water level data pre-stored in a RFID tag may be the corresponding water level value or the serial number value representing the water level value. In Step S10, RFID tags in the water level tag group are preferably arranged according to arithmetic progression in depth in the plant container, for example, one RFID tag is arranged at every 5 cm of depth, thus the obtained water level of the plant container will be more precise, wherein the difference value of water level value between two adjacent RFID tags is the detection precision. The detection precision can be improved by increasing the number of RFID tags and decreasing the difference value of water level value between two RFID tags. For example, if the difference value is 1 cm, then one RFID tag is arranged at every 1 cm of depth in the plant container, thus improves the detection precision to the order of magnitude of cm. When the water level data is a serial number value, the water level value can be obtained through the serial number value and difference value of the RFID tag.

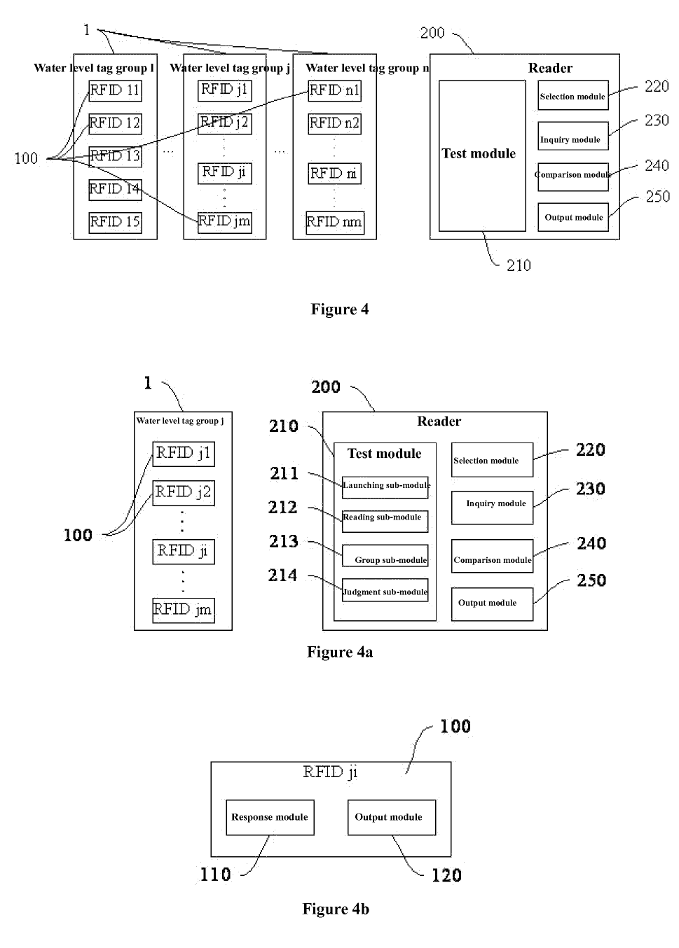

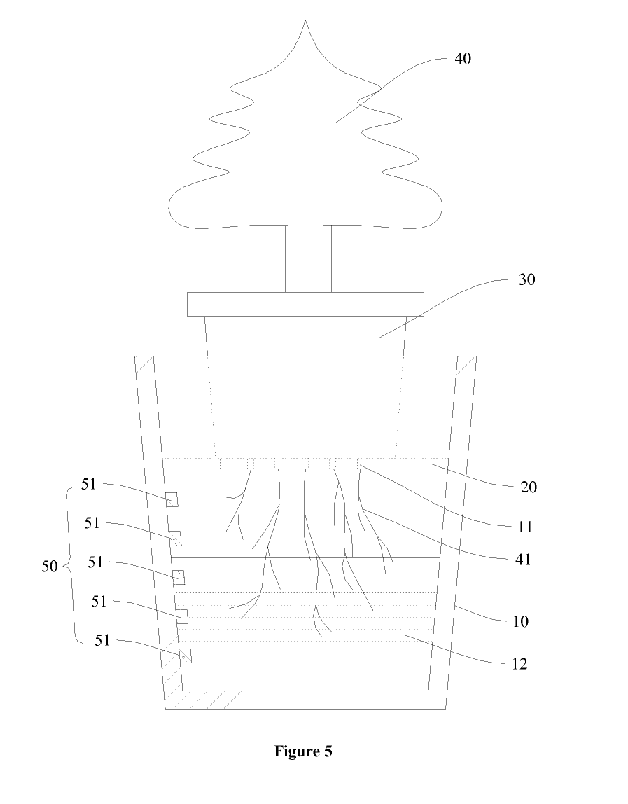

As shown in FIGS. 4, 4a and 4b, the measuring apparatus according to the present invention uses the above measuring method to detect the water level of the plant container. The preferred embodiment of the measuring apparatus comprises water level tag group 1 arranged in the plant container and portable signal transmission and receiving device 200, wherein water level tag group 1 comprises multiple RFID tags 100 arranged at different depths in the plant container; each RFID tag 100 is pre-stored with the water level data corresponding to its depth in the plant container; signal transmission and receiving device 200 comprises test module 210, selection module 220, inquiry module 230, comparison module 240, and output module 250; each RFID tag 100 comprises response module 110 and output module 120.

Test module 210 of the signal transmission and receiving device sends detection signals to detect and record complete water level tag groups in the testing area; selection module 220 selects one set from the multiple complete water level tag groups recorded by test module 210; inquiry module 230 sends inquiry signals to the RFID tags in the complete water level tag group selected by selection module 220 and reads the water level data of valid RFID tags; comparison module 240 selects the water level data representing the minimum water level value from the water level data of the valid RFID tag obtained by inquiry module 230; output module 250 converts the minimum water level data obtained by comparison module 240 to minimum water level value and outputs it.

Response module 110 in a RFID tag responds to the detection signals sent by test module 210 of the signal transmission and receiving device. Output module 120 in a RFID tag outputs the inquiry signals sent by inquiry module 230 of the signal transmission and receiving device when the RFID tag is above the water level of the plant container and returns the pre-stored water level value, and does not respond to the inquiry signals when the RFID tag is below the water level of the plant container.

Signal transmission and receiving device 200 determines whether to move signal transmission and receiving device 200 to be near the plant container through test module 210 which detects whether there is any complete water level tag group in the testing area, and determines which plant container to be inquired about water level through selection module 220 which selects one set from multiple complete water level tag groups as the object of inquiry. Through inquiry module 230 of the signal transmission and receiving device which inquires the RFID tags in the selected plant container, the water level data of valid RFID tags is obtained; through comparison module 240 which selects the water level data representing the minimum water level value and output module 250 which converts the water level data to the minimum water level value and outputs it, the real-time water level value of the selected plant container is obtained. The measuring apparatus uses the reading method via RFID wireless transmission and the water level of the plant container is detected without contact of the plant container or water in the plant container, so the use is very easy and quick; the depth interval of RFID tags in the water level tag group can be adjusted as required to obtain water level values of different precisions.

In the preferred embodiment of the measuring apparatus according to the present invention, the ID value pre-stored in each RFID tag 100 is preferably arranged to distinguish from the ID values of other RFID tags in the water level tag group; test module 210 of the signal transmission and receiving device comprises sending submodule 211, reading submodule 212, grouping submodule 213, and decision submodule 214, wherein sending submodule 211 sends detection signals to all RFID tags 100 in the testing area and all RFID tags 100 in the testing area respond to the detection signals and return ID values; reading submodule 212 reads the ID values returned by the RFID tags that have responded; grouping submodule 213 groups all ID values with this method: grouping RFID tags in the same water level tag group in the same group; decision submodule 214 judges whether the RFID tags in each water level tag group are complete in turn, that is, whether all RFID tags in the water level tag group are in the testing area. If yes, its ID value will be recorded, thus detects complete water level tag groups in the testing area.

In the preferred embodiment of the measuring apparatus according to the present invention, selection module 220 can be set to automatically select from the multiple complete water level tag groups recorded by test module 210 with the preset selection method. Preset selection methods may be selecting the complete water level tag group that appears first or last or selecting randomly. Manual selection is preferable for selection module 220 in the preferred embodiment to prevent signal transmission and receiving device 200 from frequently selecting the same complete water level tag group in the mode of automatic selection, which causes not being able to obtain the water level data of other certain plant containers. Particularly, selection module 220 of the signal transmission and receiving device comprises a display device and an input device. Selection module 220 outputs the ID values of all complete water level tag groups to the display device, and the display device shows the display data respectively corresponding to the ID values to the user; the user inputs the selection signal corresponding to the display data through the input device; selection module 220 records the ID value corresponding to the selection signal and takes the water level tag group matching with the ID value as selected complete water level tag group.

In the measuring apparatus according to the present invention, the ID value of each RFID tag is preferably arranged to comprise a set segment and a counting segment which record the set value and total number value respectively, wherein the set segment represents the water level tag group of the RFID tag and is used to distinguish from RFID tags in other water level tag groups; the total number value represents the total number of all RFID tags in this water level tag group. When the ID value of a RFID tag is obtained, the water level tag group of the RFID tag, i.e. in which plant container, and the number of RFID tags of the water level tag group can be judged based on the ID value. Grouping submodule 213 of the above signal transmission and receiving device can distinguish whether two RFID tags belong to the same water level tag group by comparing the set values in the set segments of the ID values. Decision submodule 214 of the signal transmission and receiving device can count the RFID tags in this group and compare it with the total number value in the counting segment of the ID value. If they are equal, it indicates that the group of RFID tags is a complete water level tag group; otherwise, among the group of RFID tags, part of the RFID tags in the water level tag group are not in the testing area, thus judges whether the water level tag groups are complete. In the recording of ID values of complete water level tag groups, recording of the ID value of either RFID tag in the complete water level tag group is adequate, as the set values correspond to the complete water level tag groups one by one. Thus, in selection module 220 of the signal transmission and receiving device, the complete water level tag groups can be distinguished by corresponding the set values in the ID values to the display signals one by one; likewise, after the user inputs a selection signal through the input device, selection module 220 just records the set value in the ID value corresponding to the display signal.

In the measuring apparatus according to the present invention, RFID tags in the water level tag group are preferably arranged according to arithmetic progression in depth in the plant container, for example, one RFID tag is arranged at every 5 cm of depth, thus the obtained water level of the plant container will be more precise, wherein the difference value of water level value between two adjacent RFID tags is the detection precision. The detection precision can be improved by increasing the number of RFID tags and decreasing the difference value of water level value between two RFID tags. For example, if the difference value is 1 cm, then one RFID tag is arranged at every 1 cm of depth in the plant container, thus improves the detection precision to the order of magnitude of cm. When the water level data is a serial number value, the water level value can be obtained through the serial number value and difference value of the RFID tag.

In the measuring apparatus according to the present invention, output module 120 of each RFID tag can be arranged to be concatenated with a water control switch on the surface of the RFID tag. When this RFID tag is above the water level, it is deemed a valid RFID tag; the water control switch is connected with output module 120, so that output module 120 can work, thus outputs the water level data pre-stored in this RFID tag to signal transmission and receiving device 200. When the RFID tag is below the water level, it is deemed an invalid RFID tag; the water control switch is directly conducted with the water in the plant container, which equals to grounding and disconnects the water control switch, thus output module 120 does not work and will not output water level data to signal transmission and receiving device 200.

In the preferred embodiment, the water level data pre-stored in the RFID tag may be the water level value corresponding to the RFID tag; after inquiry module 230 of the signal transmission and receiving device obtains the water level value of the valid RFID tag, comparison module 240 of the signal transmission and receiving device selects the minimum water level value and output module 250 outputs it. The water level data pre-stored in the RFID tag may also be the serial number value of the RFID tag in the water level tag group. When inquiry module 230 of the signal transmission and receiving device obtains the water level value of the valid RFID tag, comparison module 240 of the signal transmission and receiving device selects the serial number value representing the minimum water level value, i.e. the serial number value of the shallowest RFID tag in the plant container among the valid RFID tags; the water level represented by the RFID tag, i.e. the water level value of this plant container, is calculated based on the order of the serial number values and the difference value of depth between the RFID tags in the water level tag group in the plant container, and output by output module 250 of the signal transmission and receiving device.

Particularly, as shown in FIG. 4a, there are several plant containers in the testing area, that is, there are several water level tag groups, including water level tag group 1, . . . , water level tag group j, . . . , water level tag group n, wherein n is a natural number, j=1, . . . , n. Each water level tag group includes multiple RFID tags, wherein the number of RFID tags in each water level tag group may be the same or different, wherein water level tag group 1 includes 5 RFID tags, i.e. RFID11, RFID12, RFID13, RFID14, and RFID15; water level tag group j includes m RFID tags, i.e. RFIDj1, RFIDj2, . . . , RFIDji, . . . , RFIDjm, wherein m is a natural number, i=1, . . . , m; water level tag group n includes m RFID tags, i.e. RFIDn1, RFIDn2, . . . , RFIDni, . . . , RFIDnm, wherein m is a natural number, i=1, . . . , m. Assume all RFID tags in water level tag group j and water level tag group j+1 are all in the testing area; part of the RFID tags in water level tag group j−1, that is, RFID(j−1)1, RFID(j−1)2, . . . , RFID(j−1)i are in the testing area; other RFID tags are not in the testing area. When sending submodule 211 of the test module of the signal transmission and receiving device sends detection signals to all RFID tags in the testing area, RFIDj1, RFIDj2, . . . , RFIDji, . . . , RFIDjm, RFID(j+1)1, RFID(j+1)2, . . . , RFID(j+1)i, . . . , RFID(j+1)m, RFID(j−1)1, RFID(j−1)2, . . . , RFID(j−1)i in the testing area respond to the detection signals and return ID values; reading submodule 212 reads the responded ID values returned by the RFID tags; grouping submodule 213 groups all ID values; decision submodule 214 judges whether the RFID tags in each water level tag group are complete in turn, wherein water level tag group j and water level tag group j+1 are complete water level tag groups which record the ID values of either RFID tag in these two complete water level tag groups respectively.

As there are two complete water level tag groups, selection module 220 of the signal transmission and receiving device selects one of them. Assume selection module 220 selects water level tag group j which includes RFIDj1, RFIDj2, . . . , RFIDji, . . . , RFIDjm, as shown in FIG. 4a. In this case, inquiry module 230 of the signal transmission and receiving device sends inquiry signals to the RFID tags in water level tag group j. Assume RFIDji, . . . , RFIDjm in the water level tag group are below the water level, that is, they are valid RFID tags. The water control switches in these valid RFID tags are turned on, so output modules 120 in these RFID tags output the pre-stored water level data to inquiry module 230 of the signal transmission and receiving device. The water level data is preferably taken as the water level value corresponding to the RFID tag. Comparison module 240 of the signal transmission and receiving device compares the water level values and selects the minimum water level value as the water level value pre-stored in RFIDji; output module 250 of the signal transmission and receiving device outputs it, thus the water level value of the selected plant container corresponding to water level tag group j is obtained.

As shown in FIG. 5, the plant container according to the present invention may have a variety of overall structures and mainly comprises a container carrying water, soil in the container and flower planted in the soil. The purpose of the present invention is mainly to make a plant container for the above measuring apparatus and the main purpose of the above measuring apparatus is to obtain the water level value in the container, therefore the overall structure of the plant container is secondary. In the preferred embodiment of the plant container according to the present invention, the plant container of a structure is selected for elaboration.

In the preferred embodiment, the plant container comprises container 10 carrying water 12, partition 20 arranged above the water level in the container, inner pot 30 carrying soil and flower 40 planted in the soil in the inner pot, wherein the inner pot is arranged above the partition; the bottom of the inner pot and the partition are provided with many holes 11 for the roots 41 of the flower to pass through and extend to below the water level in the container; soil 31 is arranged in container 10 through inner pot 30. In order to obtain the water level value of the plant container, i.e. the water level value in container 10, water level tag group 50 is arranged in container 10 matching with the signal transmission and receiving device; water level tag group 50 comprises multiple RFID tags 51 arranged at different depths in container 10; each RFID tag 51 is pre-stored with the water level data corresponding to its depth in container 10; each RFID tag 51 comprises response module 110 and output module 120 (as shown in FIG. 4b), wherein response module 110 is used to respond to the detection signals sent by the signal transmission and receiving device in the above measuring apparatus; output module 120 is used to respond to the inquiry signals sent by the signal transmission and receiving device when RFID tag 51 is above the water level in container 10 and returns the pre-stored water level data, and not respond to the inquiry signals when RFID tag 51 is below the water level in container 10.

Particularly, RFID tags 51 in the water level tag group are preferably arranged according to arithmetic progression in depth in container 10, for example, one RFID tag 51 is arranged at every 5 cm of depth, thus the obtained water level of the plant container will be more precise, wherein the difference value of water level value between two adjacent RFID tags 51 is the detection precision. The detection precision can be improved by increasing the number of RFID tags 51 in the water level tag group and decreasing the difference value of water level value between two RFID tags 51. For example, if the difference value is 1 cm, then one RFID tag 51 is arranged at every 1 cm of depth in the container, thus improves the detection precision to the order of magnitude of cm.

Output module 120 of a RFID tag is preferably concatenated with a water control switch on the surface of RFID tag 51 (not indicated in the figure). When this RFID tag 51 is above the water level, it is deemed a valid RFID tag; the water control switch is conducted with output module 120, so that output module 120 can work, thus outputs the water level data pre-stored in this RFID tag to the signal transmission and receiving device. When the RFID tag is below the water level, it is deemed an invalid RFID tag; the water control switch is disconnected and output module 120 does not work and will not output water level data to the signal transmission and receiving device, thus realizes inquiry of the signal transmission and receiving device in the above measuring apparatus and output of water level data of valid RFID tags.

In the preferred embodiment of the plant container according to the present invention, an ID value is preferably pre-stored in each RFID tag to distinguish from the ID values of other RFID tags in the water level tag group. Response module 110 of a RFID tag returns the ID value of the RFID tag to the signal transmission and receiving device when responding to the detection signals sent by the signal transmission and receiving device for the signal transmission and receiving device to group the tags and judge whether a water level tag group is complete. Particularly, the ID value of each RFID tag can be arranged to comprise a set segment and a counting segment which record the set value and total number value respectively.

For a plant container of other structures, such as a plant container directly carrying soil and water, likewise, just arrange a water level tag group within the plant container carrying water in the plant container with the above method, and the signal transmission and receiving device of the above measuring apparatus can be used for detection, thus obtains the real-time water level value of the plant container. The structure is simple and the arrangement is easy. Common plant containers can be directly modified to be suitable for the above measuring apparatus.

While a specific embodiment of the invention has been shown and described in detail to illustrate the inventive purposes, it will be understood that the invention may be embodied otherwise without departing from said principles.

1. A water level measuring apparatus comprising:
a signal transmission and receiving device;
a container adapted for receiving a liquid;
a partition structure being mounted between the inner walls of the container having a plurality of apertures which are adapted for allowing a plurality of roots of a plant to pass through;
a reservoir adapted for storing a liquid inside the container being formed between the inner walls of the container and a lower face of the partition structure;
the container comprising a first signal device mounted inside the container;
the first signal device adapted for receiving radio-frequency signal transmitted from the signal receiver and transmitter and transmitting the radio-frequency signal to the signal receiver and transmitter;
a lower portion of the container being defined between the lower face of the partition structure and a bottom wall of the container;
the first signal device and a second signal device being positioned in different vertical positions of a wall surface of the lower portion of the container;
the first and second signal devices being spaced apart in a vertical relationship on a wall of the container;
the second signal device being positioned above the first signal device;
the first and second signal devices comprising a processor;
the processor adapted for data storing, data processing, modulating and demodulating a radio-frequency signal transmitted from the signal transmission and receiving device; and
the first and second signal devices further comprising an antenna for receiving and transmission of the radio-frequency signal.

2. (canceled)

3. (canceled)

4. (canceled)

5. The apparatus according to claim 1, wherein the first signal device is a RFID tag.

6. The apparatus according to claim 1, wherein the second signal device is a RFID tag.

7. (canceled)

8. The apparatus according to claim 1, wherein the processor comprises integrated circuits.

9. (canceled)

10. The apparatus according to claim 1, wherein the first and second signal devices do not transmit radio-frequency signal when the devices are immersed in the liquid.

11. The apparatus according to claim 1, wherein the signal transmission and receiving device comprises a network processing device for receiving data from the first and second signal devices and communicating with an information processing device through a method of electronic communication.

12. The apparatus according to claim 1, wherein the container is a plant pot.

13. A water level measuring method according to claim 1, wherein the method comprising the steps of:
setting a water level tag group is within the container, the water level tag group comprising at least one RFID tag mounted inside the container;
transmission of the radio frequency signals by the signal transmission and receiving device, the RFID tag storing electronic data comprising water level data;
testing the RFID tag of the water level tag group by the signal transmission and receiving device, the effective RFID tag being positioned above the water level of the container sends out the radio frequency signal response to the test of the signal transmission and receiving device;
the radio frequency signals being sent by effective RFID tag is received by the signal transmission and receiving device for analysis; and
reporting the user the water level data of the container by the signal transmission and receiving device.

14. A water level measuring method for a plant container according to claim 1, wherein the method comprising the steps of:
S10: setting the water level tag group inside the plant container, the water level tag group comprising at least one RFID tag mounted inside the plant container, the water level data corresponding to the depth of the plant container preset in each RFID tag; (the water level data can refer to water level values or sequential values corresponding to water level values; ID values refer to the value to distinguish one RFID tag from other RFID tags of the same water level tag group; the ID value comprising total values for distinguishing one RFID tag from other RFID tags and group type values for distinguishing one patent container from other plant containers)
S20: entering the testing area of the water level tag group for testing and recording the existence of a complete water level tag groups by the movable signal transmission and receiving device in the testing area; if there is no complete water level tag group in the testing area, the signal transmission and receiving device will not perform any operation;
S30: selecting one complete water level tag group from at least two complete water level tag groups in the testing area by the signal transmission and receiving device;
S40: inquiring each RFID tags of the selected complete water level tag group by the signal transmission and receiving device, replying the inquiry from the signal transmission and receiving device by the effective RFID tag positioned above the water level of the plant container, transmission of the water level data to the signal transmission and receiving device; no response to the inquiry of the signal transmission and receiving device made by the RFID tag positioned below the water level of the plant container;
S50: comparing the water level data between each effective RFID tags by the signal transmission and receiving device, selecting one water level data of a minimum water level value, converting the one water level data into a minimum water level value for output.

15. The method according to claim 14, wherein the S30 comprises a preset selection method, the signal transmission and receiving device selects one complete water level tag group from at least two complete water level tag groups in the preset selection method, the preset selection method can select a first complete water level tag group or select a last complete water level tag group or make random selection.

16. The method according to claim 14, wherein each RFID tag stores a ID value for distinguishing one RFID tag from other RFID tags of the same water level tag group, the S20 comprising the steps of:
S21: testing the existence of the RFID tag in the testing area; if the RFID tag appears in the testing area, the signal transmission and receiving device reads the ID value of the RFID tag; if no RFID tag appears in the testing area, no action will be taken by the signal transmission and receiving device;
S23: according to the ID value, the signal transmission and receiving device groups all RFID tags in the manner of classifying RFID tags in the same water level tag group into the same group;
S25: the signal transmission and receiving device judges whether RFID tags in each water level tag group are complete, and records the ID value of each complete water level tag group; if there is no complete water level tag group, then no action will be taken by the signal transmission and receiving device.

17. The method according to claim 16, wherein the signal transmission and receiving device comprising a display device and a input device, the signal transmission and receiving device of the S30 selecting one complete water level tag group by the steps of:
S31: the signal transmission and receiving device outputs the ID values of all complete water level tag groups to the display device, and the display device displays a display data corresponding to all ID values;
S33: the user inputs a selection signal corresponding to the display data; and
S35: according to the selection signal, the signal transmission and receiving device records the ID values corresponding to the display data, and take such water level tag group corresponding to the ID value as the selected complete water level tag group.

18. The method according to claim 14, wherein all RFID tags of the S10 are in a vertical relationship and are spaced apart with a same distance.

19. A measuring device of the method according to claim 14 comprising the water level tag group mounted inside the plant container and the movable signal transmission and receiving devices, the said water level tag group comprising at least two RFID tags mounted inside the plant container at different vertical positions, each the RFID tag preset with the water level data corresponding to a preset vertical position in the plant container, the signal transmission and receiving device comprising:
Test module, to send test signal test and record complete water level tag groups in the testing area;
Selection module, to select one water level tag group from complete water level tag groups;
Inquiry module, to send an inquiry signal to all RFID tag in the complete water level tag group and read the water level data of the effective RFID tag;
Comparison module, to select the water level data from the minimum water level value of the effective RFID tag acquired from the inquiry module;
Output module, to convert the water level data acquired from the comparison module into the minimum water level value for output;
The RFID tag comprising:
Response module, to respond a test signal sent by the test module of the signal transmission and receiving device;
Output module: When this RFID tag is positioned above the water level of the plant container, it responds to the inquiry signal sent by the inquiry module of the signal transmission and receiving device, and returns to the preset water level data, but when this RFID tag is positioned below the water level of the plant container, it will not respond to the inquiry signal.

20. The measuring device according to claim 19, wherein the RFID tag is preset with the ID value for distinguishing one RFID tag from other RFID tags of the same water level tag group and the test module of the signal transmission and receiving device comprising:
Transmission sub-module, to send a test signal;
Reading sub-module, to read the ID value returned by the RFID tag existing in the testing area;
Grouping sub-module: according to the ID value acquired from the reading sub-module, to group all RFID tags in the manner of classifying the RFID tags in the same water level tag group into the same group;
Decision sub-module: to decide whether RFID tags in each water level tag group are complete and to record the ID value of each complete water level tag group.

21. The measuring apparatus according to claim 20, wherein the selection module of the signal transmission and receiving device further comprising the display device and the input device, the selection module inputting the ID value of all complete water level tag groups into the display device; the display device displays to the user the display data corresponding to the ID value, the user inputs one selection signal corresponding to the display data; the selection module records the ID value corresponding to the display data and takes water level tag group corresponding to the ID value as the selected complete water level tag group.

22. The measuring apparatus according to claim 19, wherein all RFID tags are in a vertical relationship and are spaced apart with a same distance.

23. The measuring apparatus according to claim 19, wherein the water level data preset in the RFID tag is the water level value corresponding to the RFID tag.

24. The measuring apparatus according to claim 19, wherein the water level information preset in the RFID tag is the sequential value of the RFID tag of the water level tag group.

25. A plant container of the measuring apparatus according to claim 19, wherein the plant container comprises the water level tag group corresponding to the signal transmission and receiving device, the water level tag group comprises at least two RFID tags positioned in different vertical position of the plant container, each RFID tag is preset with the water level data corresponding to the vertical positions of the plant container; the RFID tag comprises the response module for replying the test signal sent by the signal transmission and receiving device and the output module for replying the inquiry signal from the signal transmission and receiving device and records the water level data when the RFID tag is positioned above the water level of the plant container, the output module will not respond the inquiry signal when the RFID tag is positioned below the water level of the plant container.

26. The plant container according to claim 25, wherein the RFID tag is preset with the ID value for distinguishing one RFID tag from other RFID tags of the same water level tag group, the response module of the RFID tag responds to the test signal sent by the signal transmission and receiving device and returns to the ID value of the RFID tag.

27. The plant container according to claim 25, wherein the ID value of the RFID tag comprises group sections and counting sections for recording the information of group values and total value.

28. The plant container according to claim 25, wherein the position of all RFID tags mounted inside the plant container is of a same vertical distance.

29. The plant container according to claim 25, wherein the water level data preset in the RFID tag is the water level value corresponding to the RFID tag.

30. The plant container according to claim 25, wherein the water level information preset in the RFID tag is the sequential value of the RFID tag of its water level tag group.
